(19) United States
(12) Patent Application Publication
(10) Pub. No.: US 2018/0240162 A1
(43) Pub. Date: Aug. 23, 2018

(54) CONVERSATIONAL COMMERCE PLATFORM

(71) Applicant: Koopid, Inc., San Ramon, CA (US)

(72) Inventors: Venkatesh Krishnaswamy, San Ramon, CA (US); Shalini Yajnik, Berkeley Heights, CA (US); Kundan Singh, San Francisco, CA (US); Ajita John, Holmdel, NJ (US); Ramanujan Kashi, Bangalore (IN); Jaimon Jose, Bangalore (IN); David Skiba, Golden, CO (US)

(21) Appl. No.: 15/902,652

(22) Filed: Feb. 22, 2018

Related U.S. Application Data
(60) Provisional application No. 62/462,227, filed on Feb. 22, 2017.

(51) Int. Cl. G06Q 30/02; H04M 3/51; H04L 12/58; H04M 3/523; H04N 7/14

(52) U.S. Cl. CPC G06Q 30/0281; H04M 3/5191; H04N 7/141; H04M 3/5238; H04L 51/36

(57) ABSTRACT

Communications often require the prior selection of a particular mode of communications. A voice call requires initiation of a telephone connection (e.g., dialing a number) in a telephone application or interface, an email communication requires selection of an email address in an email application or the launching of such an email application. Omni-channel communications, as described herein, enable a connection to be initiated in a unified platform for any available mode of communication. Communications may incorporate workflow management and widgets to dynamically present or receive information from a user or access other device hardware (e.g., camera, GPS receiver, etc.) or data (e.g., images, videos, documents, etc.).

### CROSS-REFERENCE TO RELATED APPLICATIONS

The present application claims the benefit of Provisional Patent Application No. 62/462,227, filed on Feb. 22, 2017, and is incorporated herein by reference in its entirety and for all that it teaches.

### FIELD OF THE DISCLOSURE

The present disclosure is generally directed toward connectivity nodes on a network and more specifically connectivity utilizing a plurality of communication types.

### BACKGROUND

Communication devices are readily available that support a plurality of communication types. For example, smart phones and personal computers can communicate via text chat, video chat, proprietary communications (e.g., multi-player/multi-device games), and voice, usually via a cellular or WiFi radio link, to Plain Old Telephone System (POTS) and Session Initiation Protocol (SIP) networks.

In many communication situations one party, on one device, wishes to communicate with another party over a network. If they wish to communicate via a voice telephone call, the number is located and selected or entered and the call is placed. If the communication requires another mode of communication, such as screen sharing, video, whiteboarding, images, etc., then another communication session is established outside of the telephone call. If the party wishes to communicate in text, a text number is located and a text communication application utilized and so on for email, video, etc. Even if a communication channel is established between the parties using one communication type, a separate communication session may be required if the parties need to utilize another communication type. For example, an audio conversation that requires the parties to exchange a document or image may require one party to provide another mode of communication (e.g., email, text, etc.) in which the document may be sent. Even applications that allow for multiple modes of communications (e.g., text or email with attached documents or images) require one to first know what communication modes are available, the application or mode-specific address to use to initiate such communications, and hope the called party is available to accept the calls utilizing the mode or modes selected. While such prior art systems may accomplish the goal of enabling communications via one or more communication modes or types, problems remain.

### SUMMARY

It is with respect to the above issues and other problems that the embodiments presented herein were contemplated.

Systems, components, and methods are provided to enable a rich communication experience, such as between a customer and a business. However it should be appreciated that the communications described herein may be utilized by other types of entities (e.g., government, education, individuals, etc.) without departing from the scope of the disclosure. The term “business” and “customer” are provided to promote understanding and without limiting the parties involved except as provided herein. In one embodiment, a communication platform is provided that enables communications between parties in any number of modes, switching between modes, maintaining multiple modes, while exchanging content via executable widgets pushed from an agent (business) platform to a customer device engaged in the communication.

One party (e.g., a business) utilizes computing and network connectivity equipment to establish an agent platform, such as on one or more servers attached to a network, whereby attributes of the business are provided and then made available to another party (e.g., a customer) utilizing computing and network connectivity equipment. The attributes may be one or more of static, or at least effectively static (e.g., name of business, physical address, etc.), or dynamic (e.g., today's specials, wait time to video-chat with an agent, availability of a specific loan officer to discuss an application, etc.). A workflow may comprise automated (e.g., “bot”) interactions, human interactions, bot prompted human interactions, human-supervised bot interactions, and/or other workflow components to perform a particular task of the business. The business may script or, via API, integrate existing workflows. Workflows may also be partially or entirely dynamically determined and/or ad hoc. As the workflow progresses, executable components (“widgets”) are pushed to the client device for execution. The widgets provide a compartmentalized component which may enable an alternative mode of communication (e.g., view a video link, share a document, etc.), present and/or obtain information from the customer. Other widgets, including business-specific widgets, are also contemplated by the disclosure herein which may further include, but is not limited to parallel-executing, nested, and/or recursive widgets.

In another embodiment, an interaction between a customer and business may be annotated by the customer and/or a bot or human input provided by the business and the interaction, with any annotations, maintained in a data storage. As a benefit, any or re-initiation of an interaction between the customer and the business may be resumed seamlessly. In another embodiment, an interaction is preserved to maintain a persistence of a particular transaction of a workflow. For example, an interaction that comprises eight steps to complete, but was previously terminated upon completion of step five, may be resumed in the workflow and be re-initiated at step six. Summary widgets may be provided to represent a high-level view of a workflow or task, such as a completed task, incomplete task, etc.

In one embodiment, a mobile messaging platform is disclosed, comprising: a user interface that presents a consumer with information describing a plurality of service providers that meet a search criteria entered by the consumer; and computer memory storing one or more instruction sets, the one or more instruction sets including an instruction set that: enables a determination of business availability information for at least one of the plurality of service providers, the business availability information including one or more of: (i) a presence notification for the at least one of the plurality of service providers, (ii) a communication modality useable between the consumer and the at least one of the plurality of service providers along with a schedule of availability for the communication modality, and (iii) communication history between the consumer and the at least one of the plurality of service providers; and enables a presentation of the business availability information via the user interface along with static information associated with the plurality of service providers that meet the search criteria.

In another embodiment, a server is disclosed, comprising: a data storage; a network interface to a network; and a processor to: maintain, in the data storage, indicia of an entity; obtain a dynamic attribute, via the network interface, with an entity server of the entity and wherein the dynamic attribute comprises a plurality of communication modes; receive an entity request, via the network interface, for the indicia from a user device; send the indicia and dynamic attribute to the user device; receive a selection of one of the plurality of communication modes, from the user device, to communicate with the entity and wherein the selected communication mode comprises at least a portion of the dynamic attribute; and connect the user device with the entity utilizing the selected one of the communication modes.

In another embodiment, a method is disclosed, comprising: maintaining a listing comprising at least one entry and wherein each entry comprises indicia of an entity; obtaining, a dynamic attribute for each entry from a corresponding server of the entity and wherein the dynamic attribute comprises a status of a communication mode; receiving request from a user device for the listing; in response to the received request, sending the listing; receiving, from the user device, a selection, comprising a selected one of the at least one entry and the communication mode; and connecting the user device with the entity utilizing the communication mode.

The phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known to as “the cloud,” but may include a public, private, dedicated, shared and/or other service bureau, computing service, and/or “server farm.”

The terms “determine,” “calculate,” and “compute,” and variations thereof, as used herein, are used interchangeably and include any type of methodology, process, mathematical operation, or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a first user device displayed content in accordance with embodiments of the present disclosure;

FIG. 3 depicts a second user device displayed content in accordance with embodiments of the present disclosure;

FIG. 4 depicts a first portion of system 100 in accordance with embodiments of the present disclosure;

FIG. 5 depicts a second portion of system 100 in accordance with embodiments of the present disclosure;

FIG. 6 depicts certain roles components of system 100 in accordance with embodiments of the present disclosure;

FIG. 7 depicts an interaction in accordance with embodiments of the present disclosure;

FIG. 8 depicts a widget “push” in accordance with embodiments of the present disclosure;

FIG. 9 depicts a workflow in accordance with embodiments of the present disclosure;

FIG. 10 depicts a first widget in accordance with embodiments of the present disclosure;

FIG. 11 depicts a second widget in accordance with embodiments of the present disclosure;

FIG. 12 depicts a third widget in accordance with embodiments of the present disclosure;

FIG. 13 depicts a fourth widget in accordance with embodiments of the present disclosure; and

FIG. 14 depicts a process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form and are well known or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

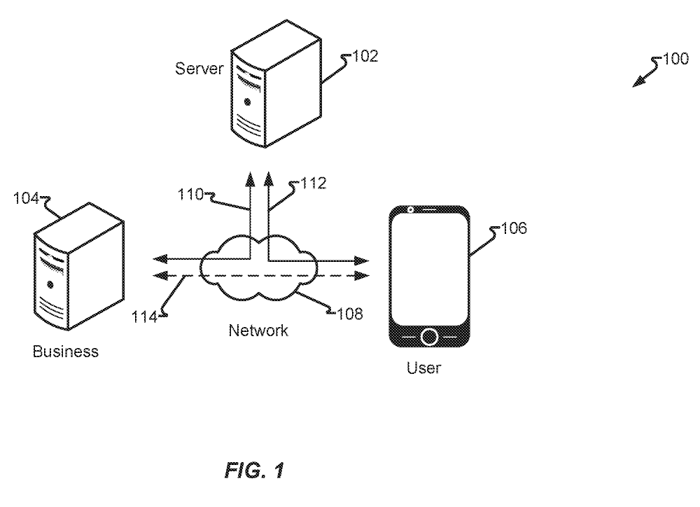

FIG. 1 depicts system 100 in accordance with embodiments of the present disclosure. In one embodiment system 100 depicts server 104, server 102, and user device 106 in communication via network 108. Network 108 may be a single networking platform (e.g., LAN via Ethernet or WiFi connection), or combination of interconnected networking platforms (e.g., cellular telephone network, Internet, WiFi, WAN, LAN, etc.). Server 104, server 102, and user device 106 each comprise at least one processor, memory for the storage of data and/or instructions for the processor, a network interface (e.g., radio frequency transmitter/receiver, NIC, etc.) to network 108. The memory may be provide by retrievable storage of data encoded in a medium that may be magnetic, optical, electronic, or a combination thereof. Additionally or alternatively, server 102 and/or server 104 may comprise a plurality of processors and storage devices to comprise a “server farm” or “cloud” processing/data storage system. Server 102 and/or server 104 may be dedicated components or shared to provide services to other systems and/or users. In another embodiment, user device 106 may be embodied by two or more associated components, such as a wearable device paired with a smart phone, such as a “smart watch,” display goggles, virtual reality headset, ear phones, etc.

In another embodiment, user device 106 additionally comprises at least one human input-output component (e.g., speaker, microphone, display, touch-screen display, switches, buttons, etc.) and may further comprise radio frequency transmitters and/or receivers for WiFi, Bluetooth, Near Field Communications, GPS, infrared communications, etc., as well as other computing peripheral components, still camera, video camera, accelerometer, vibration/haptic input/output, orientation, compass, altimeter, etc. In one embodiment, user device 106 is a “smart phone” (e.g., a portable cellular telephone having input, output, and data processing capabilities beyond those required to enable placing and receiving cellular telephone calls). In another embodiment, user device 106 is a personal computer (e.g., laptop, desktop, tablet, etc.).

In another embodiment, some or all instructions executed by the processor of at least one of user device 106, server 102, or server 104 are the sole result of electrical signals through circuitry, such as in an ASIC. While it is helpful to the understanding of the embodiments herein to consider server 102 and server 104 as distinct, in other embodiments, server 102 and server 104 may be co-located or otherwise combined in whole or in part. For example, server 104 may be embodied as a desk top computer utilized by a human to access information stored and/or processed by server 102.

In another embodiment, user device 106 communicates with server 102 via communication link 112 comprising, in whole or in part, network 108. Server 102 and server 104 communicate via communication link 110 comprising, in whole or in part, network 108. Server 104 and user device 106 may communicate directly via communication link 114 or indirectly, via communication links 110 and 112. User device 106, via communications link 112, may provide the appearance of communicating with server 104 while communicating solely with server 102 or with server 104 via server 102. In another embodiment, server 104 is a component of a business entity and server 102 is a component of a service provider distinct from the business entity and server 104, user device 106 is associated with a user, such as a customer (current or prospective), of the business entity.

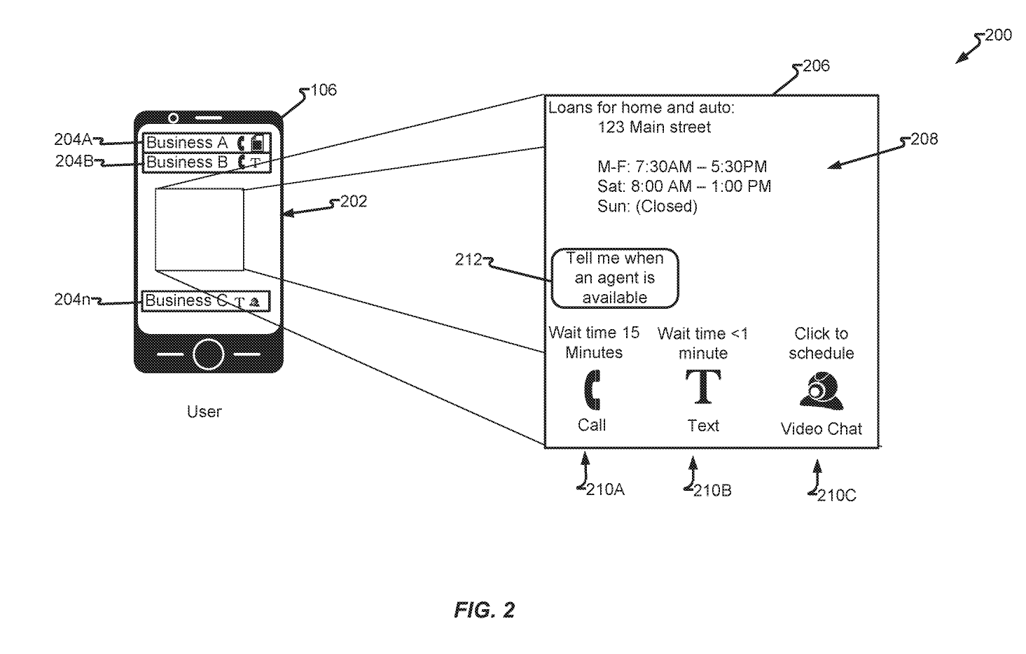

FIG. 2 depicts user device displayed content 200 in accordance with embodiments of the present disclosure. In one embodiment, user device 106, utilizing communication link 112 to communicate with server 102, obtains one or more business listings 204 for presentation on display 202. It should be appreciated that non-business entities, groups, and/or individuals' listings may additionally or alternatively be utilized without departing from the scope of the embodiments. One or more business listings 204 may comprise an icon or other indicia of available and/or schedulable modes of communication that may be utilized for a user of user device 106 to communicate with a particular business, including, but not limited to, an icon of a telephone handset to indicate voice telephone calls, a letter of the alphabet to indicate text chat, a thumbnail image of a document to indicate document exchange, a web camera to indicate video chat, camera to indicate image exchange, etc.

In another embodiment, display 202 presents information 206, such as regarding listing 204B (“Business B”). Information 206 comprises information accessed from server 102 which may have been obtained from information maintained by server 102 and/or information maintained by server 104, and accessed, such as via one or more APIs, by server 102. Accordingly, information 206 may comprise static information, such as modes of communication 210 that may be utilized by a user of user device 106 to communicate with the business. Additionally or alternatively, user device 106 may access data, via one or more APIs, from server 102 and/or server 104.

In another embodiment, modes of communication 210 may present via icon or other indicia to indicate options to communicate with a selected business and information related to one or more modes of communication 210, which may be dynamic. For example, mode of communication 210A comprises a voice call (e.g., POTS, SIP, VoIP, etc.) and additional information (e.g., the caller should expect to be on hold for fifteen minutes before talking with an agent). Mode of communication 210B comprises a text chat and additional information (e.g., that a wait of less than a minute should be expected before receiving an agent's response). Mode of communication 210C comprises a video chat and is currently unavailable. Video chat, or any one or more modes of communication 210 may be unavailable due a lack of available resources (e.g., processing, communication, agent communication devices utilized by human agents, etc.) to provide communications utilizing that particular mode or modes. As an alternative, customers who require or request the use of a particular mode, that is presently unavailable, may have the option to be notified, such as via prompt 212 or to schedule communication for a future time, such as by selecting an icon associated with mode of communication 210C. In another embodiment, a delay may cause a widget comprising a game, news feed, or other component to provide information or entertainment, or otherwise make the delay more palatable to the user.

In another embodiment, selecting prompt 212 may place the user in a call-queue for the business without requiring the call to be placed, such as via selection of the icon associated with mode of communication 210A. For example, agents may be engaged with other tasks and once the user of device 106 has been enqueued, the text of icon 212, via API and/or other data exchange with server 102 and/or server 104, may issue updates (e.g., count down timer, number of callers ahead in the queue, etc.). When the call is ready to be answered by an agent, the agent, server 102 and/or server 104 may trigger a callback to user device 106 or prompt the user to place the call where it is connected to an agent or joined to the placeholder indicating the caller's position in the queue. Connections may be made automatically, such as when certain steps in a workflow are completed or a particular widget or other action is performed. Such connections may be made automatically or request confirmation by the user and/or agent before proceeding. In other embodiments, other callbacks and/or scheduling may be provided for text, video, or other communication modes.

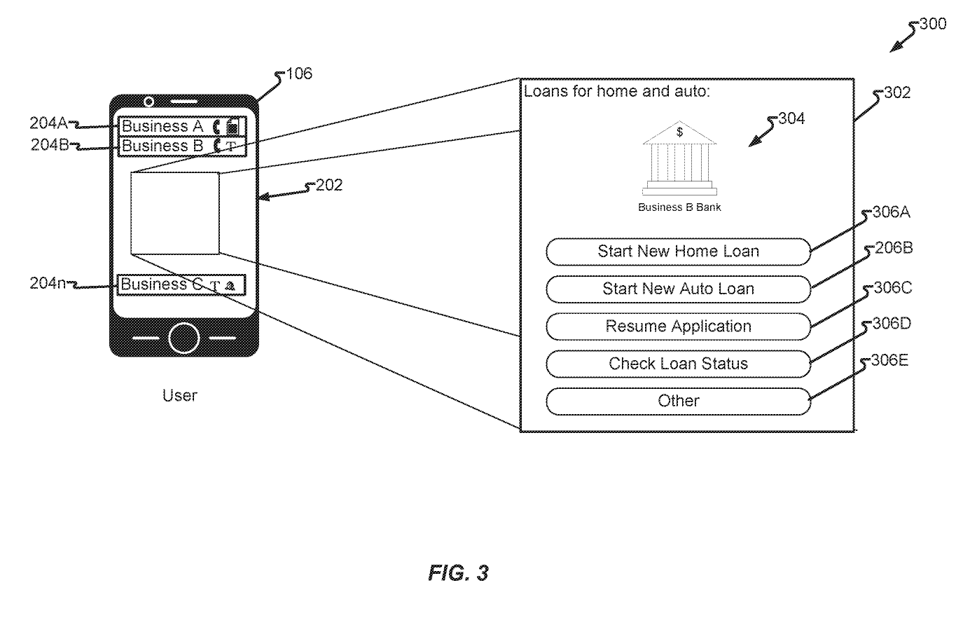

FIG. 3 depicts user device displayed content 300 in accordance with embodiments of the present disclosure. In one embodiment, information 302 indicates static information, such as business's logo 304, text, address, etc. In another embodiment, one or more actions 306 may be indicated, such as those most likely to be requested and/or those which have a particular resource available. For example, an automated script may execute as a “bot” to allow automated interactions between a user of user device 106 and a business indicated by business listing 204B. If human agents are not available (e.g., holiday, weekend, outside of banking hours, etc.), then actions associated with human agents may not be presented in actions 306. Additionally or alternatively, actions 306 may present options to perform actions, even if such actions are not presently possible, such as to enable a user to schedule a future interaction or find other options.

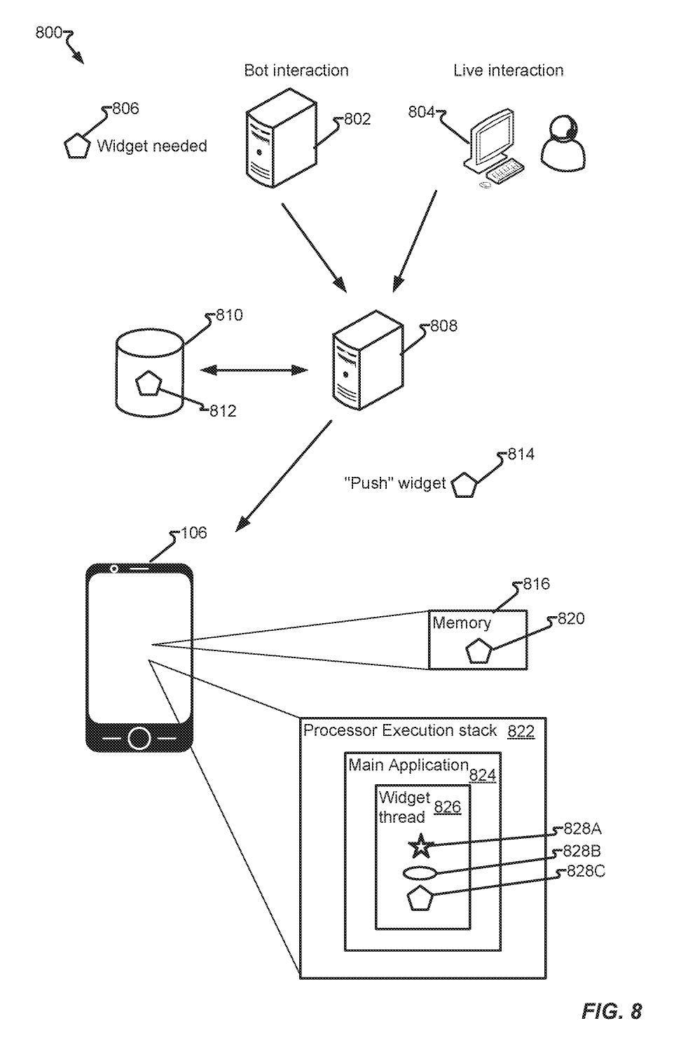

In one embodiment, actions 306A-306D are associated, in whole or in part, with an automated workflow which may be executed by one or more widgets “pushed” from server 102. Pushing, executing, and utilizing widgets is explained more completely with respect to the interaction depicted by FIG. 8.

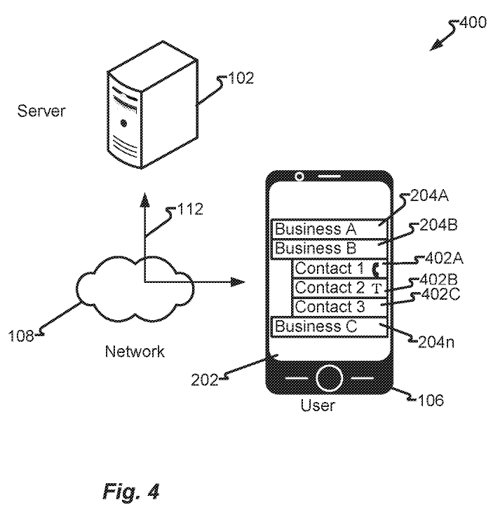

FIG. 4 depicts portion 400 of system 100 in accordance with embodiments of the present disclosure. In one embodiment, portion 400 comprises communication link 112 between user device 106 and server 102 via network 108. Display 202 presents information retrieved from, via download and/or push, server 102. Server 102, in turn, may provide the information maintained by itself or associated component (e.g., one or more database servers) and/or via API connection to another component, such as a directory application provided by server 104 (not shown).

In another embodiment, display 202 presents updated and/or detailed information. For example business listing 204B is selected and additional information 402 is provided, such as specific contacts 402A-C. Specific contacts 402 may be individuals, departments, divisions, groups, etc. Additionally or alternatively, icons or other indicia of modes of communication, availability, or further details may allow a user to “drill down” into information available. For example, additional information 402A, may indicate the contact is, or can be, available for telephone interactions, additional information 402B is, or will be, available for text chat, and additional information 402C is not currently available or may require additional “drilling down” such as when additional information 402C comprises a department, division, or other group that has individual listings. Server 102 may provide all information, whether selected or not for one or more business listings 204, or detailed information as it is selected.

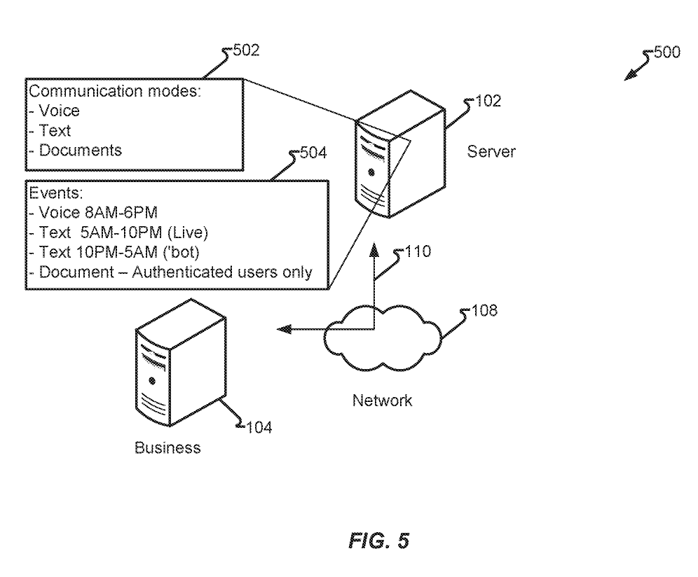

FIG. 5 depicts portion 500 of system 100 in accordance with embodiments of the present disclosure. In one embodiment, server 102 is in communication with server 104, via communications link 110 comprising, in whole or in part, network 108. In one embodiment, server 104 may provide setup or configuration settings to server 102, such as to provide static information 504 regarding a business (e.g., mailing address, hours of operation, etc.). It should be appreciated that static information 504 is capable of changing, but such changes are uncommon if they occur at all and remain unchanged absent unusual circumstances. It should also be appreciated that static information may be updated periodically or continually, even if the values remain unchanged. Dynamic information 504 may be provided via API to a system executing on server 104. For example, business 104 may be executing a call center and available modes of information and/or wait times are provided via dynamic information 502. Server 102, such as when queried by user device 106, may then present the dynamic information to user device 106.

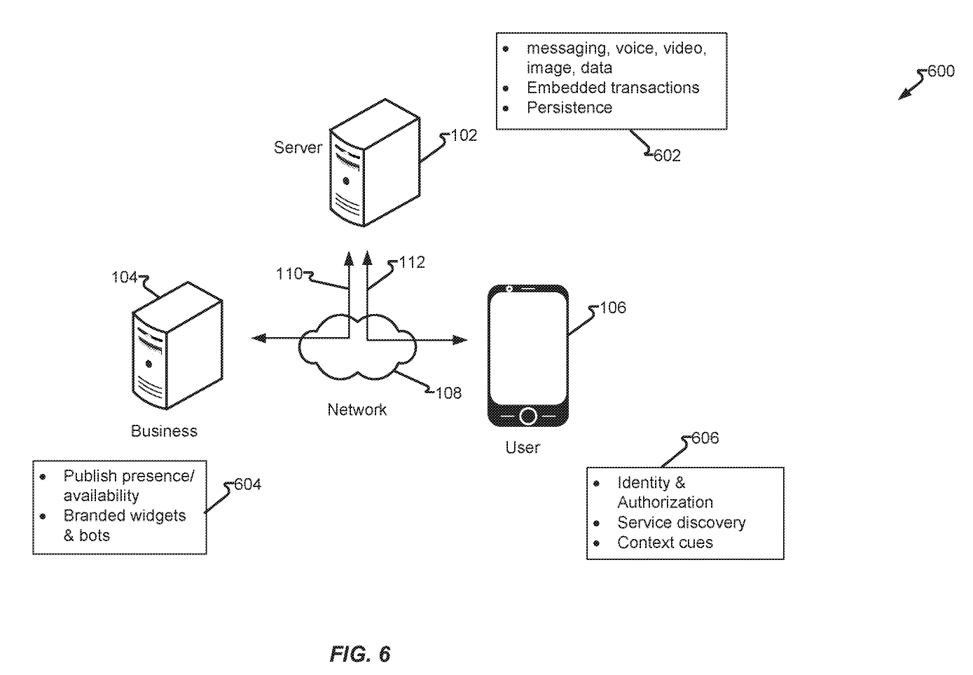

FIG. 6 depicts system 600 in accordance with embodiments of the present disclosure. In one embodiment, server 102 enables connectivity between user device 106 and server 104 via communication links 110 and 112 to provide one or more features 602. For example, server 102 may serve as a conduit for communications, provide transaction, data recording for persistence of interactions, and a repository of widgets that may be pushed to user device 106 to enable a particular portion of an interaction between user device 106 and server 104. Persistence may comprise maintaining prior progress in a workflow such that steps to complete a particular task, which were completed in a prior interaction, may be resumed at the next uncompleted task without requiring restarting the workflow. In another embodiment, persistence may be a summary or overview widget, such as to indicate a particular workflow has been completed, abandoned, or other state. Such a summary widget may comprise summary views of one or more individual widgets therein. For example, a summary widget may indicate that a loan application was completed last month and/or attributes utilized for the summary widget (e.g., loan amount, property address, payment, etc.) but omit details utilized in the underwriting or application process. However, such details may still be available or made available to support auditing or other detailed review.

In another embodiment, user device 106 provides one or more features 606. For example, a user of user device 106 may be authenticated to user device 106 via password, access code, facial recognition, voice recognition, etc. Server 102 may then receive such identification which may, or may not, be provided to server 104 or any one or more of a plurality of servers 104 associated with a corresponding one or more of a plurality of businesses. For example, user device 106 may provide, or be able to provide, authentication information but omit such information, such as a user who wishes to remain anonymous. Additionally or alternatively, identification may be expressly provided or selected. For example, user device 106 may be shared by two or more people, each with an account at a particular business. Accordingly, user device 106 may provide authentication information indicating a default user or alternative user. In yet another embodiment, user device 106 may provide context cues to server 102 which may in turn provide such cues to business 104. For example, a GPS receiver and processor of user device 106 may provide location information. Location information may be relevant (e.g., a request for roadside assistance) or if not, omitted or ignored. Location information may be compared to a repository of relevant locations for the business associated with server 104. For example, an appliance store may not be interested that a user is initiating contact from a particular latitude and longitude, unless such a location indicates the address of a competitor's store or the business's own store. Then location may be highly relevant and the business may process the interaction differently as compared to location information that indicated a house in a residential neighborhood.

In another embodiment, server 102 and user device 106 may enable service discovery, such that a directory of available businesses (e.g., listings 204) is available for browsing, searching, filtering, etc. saving favorites, saving previously contacted businesses, etc. Listings may be searched, filtered, etc. based on business type, location, methods of available communication, etc. For example, one may have an urgent, but non-emergency, medical situation and know that video or still pictures will be important to determine a subsequent action required. Accordingly, a user may cause user device 106 to communicate with server 102 to identify health care providers and those that are available right now to communicate and can support communications comprising video and/or still images.

In another embodiment, server 104 provides one or more features 604. For example, server 104 may be executing an application that maintains availability for one or more resources and/or their current (or schedulable) modes of communication. Server 102 may access such information, via API or other data exchange, and integrate such information in to the presence information presented to user device 106. Server 104 may also provide customized graphical or other elements (e.g., tag lines, logos, etc.) to server 102 to provide a branded presentation for a particular business upon user device 106. Additionally or alternatively, server 104 may select, make available, and/or provide widgets to server 102 to incorporate into an interaction with user device 106. Such widgets may be graphically or otherwise branded for the particular business and/or provide or request information selected by the business as indicated by server 104.

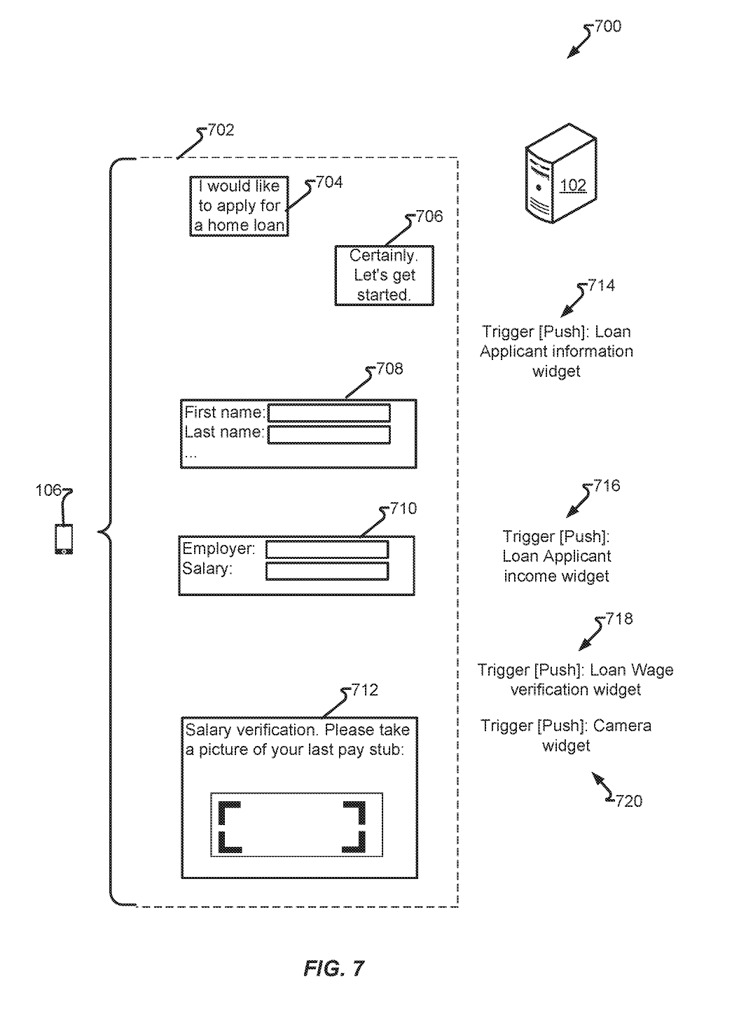

FIG. 7 depicts interaction 700 in accordance with embodiments of the present disclosure. In one embodiment, user device 106 is engaged in interaction 702 with server 102. Via selection of an option or free-form question, input 704 is provided by user device 106 to server 106 to identify a requested service (e.g., home loan). Server 102 responds with response 706 which may be the result of the execution of an automated script by server 102 or as a pass-through message from server 104, which in turn is a response generated by an automated script and/or human input to a device in communication with server 104. As a part of interaction 702, certain information may be known to be presented or obtained, such as via a workflow maintained on server 102 or server 104 and accessible to server 102. Accordingly, server 102 performs widget-push 714 whereby an executable portion of code, widget 708, is sent to user device 106 and executed by a processor of user device 106 as a component of interaction 702.

In another embodiment, a user provides inputs to widget 708 to indicate that the task associated with widget 708 has been completed or otherwise indicates the user is done interacting with widget 708. In series or parallel, another widget, widget 710 is provided to user device 106 via widget-push 716, which is then executed by user device 106. Widgets may trigger other widgets, for example widget-push 718 may itself cause widget-push 720, such as to present widget 712.

Server 102 may operate other processes in parallel with interaction 702, for example, components of interaction 702 may be recorded and/or annotated by a human agent, bot, and/or a user associated with user device 106. A separate chat widow (not shown) may be available to ask questions or otherwise provide out-of-dialog communications (e.g., “Here is a picture of my regular paystub, but I get quarterly commission checks starting next month. Let me know if that will be an issue.”).

Widgets may have graphical representations, such as widget 708, 710, and 712 to provide and/or obtain information from a user via user device 106. Widgets maybe scripts or other executable (HTML5, JavaScript, etc.) that, when received by user device 106 within an application utilized for interaction 702, causes the widget to execute. In another embodiment, user device 106 comprises at least one processor. Pushing a widget to an application capable of executing widgets causes the widget, once received into a memory of device 106, to insert the widget into an execution stack of the application and/or the operating system. Accordingly, the widget may execute immediately upon being loaded into memory. However, widgets may also be anticipated and pushed to device 106 to await execution, such as by an application presenting an interaction and waiting for a particular event to occur. For example, an application presenting enabling interaction 702 may know that certain widgets (e.g., 708, 710, 712) will be required and push widgets 708, 710, 712 in advance. An event (e.g., asking for particular piece of information, completion/dismissal of a previous widget, etc.) may then cause a loaded widget to execute.

In another embodiment, widgets may have a state, such as active, completed, and/or historic. For example, during completion of workflow 702, widget 710 may be active, such that it is not completed, or completed but the user may go back and edit the information previously entered. However, at a later point in time, the information provided into widget 710 may no longer be accurate (e.g., the user changed employers, received a raise, etc.). Accordingly, the widget may be have a historic state to indicate the information provided reflected the information at a prior time. Similarly, a widget that displays bank account information may be utilized to determine the state of certain assets utilized in workflow 702. Such information may be dynamic and a subsequent interaction may cause an account balance widget to be identified as historic and display information such as the balance of the account at a particular date and time or that the account balance widget was accessed with balance information omitted. Summary widgets may similarly be preserved such as to maintain a widget providing a summary of a task or an interaction with a particular customer-business. For example, a customer may have a completed home loan summary widget, an inquiry into an auto loan, and an in-progress credit card application maintained as a persistent widget.

FIG. 8 depicts widget “push” 800 in accordance with embodiments of the present disclosure. In one embodiment, bot 802 and/or a human agent utilizing agent communication device 804 determines that widget 806 (symbolically represented as a pentagon) is needed for an interaction. Bot 802 may be executing an automated workflow comprising an indication for a need for widget 806. Similarly, human agent utilizing agent communication device 804 may determine, via monitoring an automated workflow, performing a semi-automated workflow, and/or other means to determine that widget 806 is needed for a particular interaction. Accordingly, bot 802 and/or human agent utilizing agent communication device 804 signals server 808 to push widget 806 to user device 106.

In another embodiment, server 808 accesses database 810 comprising a stored widget 812, which may be widget 806 or associated with widget 806 when widget 806 is an indicia of widget 812. Server 808, in communication with user device 106 then pushes widget 814, comprising a transmitted copy of widget 812. Database 810 may be a dedicated widget database or combined with other database tasks, such as maintaining interaction histories, user information, business information, and/or other information related to past, current, and/or future interactions.

In another embodiment, user device 106 comprises memory 816 and at least one processor comprising execution stack 822. Transmitted widget 814, once received is stored in memory 816 as widget 820. Execution stack 822 executes main application 824, such as to facilitate the interaction (e.g., connectivity to server 808, presentation and receiving of information, access to GPS, camera, and/or other components, etc.). Main application 824 may have an execution thread comprising a number of widgets 828, which may comprise address pointers, such as when widgets 828 are addresses to widgets in memory 816, such as 828C indicating the location of widget 820.

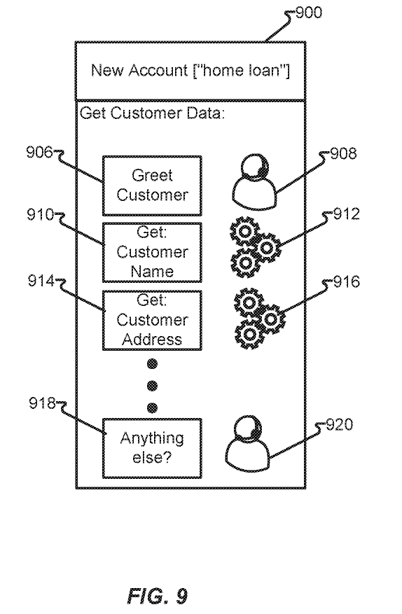

FIG. 9 depicts workflow 900 in accordance with embodiments of the present disclosure. In one embodiment, workflow 900 may comprise automated and/or manual portions of an interaction between user device 106 and server 102. The manual portions being performed by a human with respect to an agent communication device. In other embodiments, a workflow may be entirely automated or entirely manual. Workflow 900 may comprises an indicia (home loan) indicating a purpose or other identifier. The indicia may be presented to a user, such as one or more actions 306 (see FIG. 3).

Step 906 identifies an action and actor icon 908. In one embodiment, actor icon 908 may indicate the actor to be a human agent, an agent with a particular attribute (e.g., “Loan processing agent,” “Agent based in Eastern Time Zone,” “Agent Fluent in French,” etc.), or a specific agent, such as when a particular customer associated with an interaction has a history with the business. Next, step 910 is performed by bot indicated by actor icon 912, indicating that it is an automated task performed by a processor, such as server 102 which may push a widget to user device 106 for the completion of step 910. Next, step 914 is also performed by a bot indicated by actor icon 916. Additional steps may be performed. Step 918, may be a closing step performed by a human agent indicated by actor icon 920. The actor indicated by actor icon 920 may further indicate any agent, the same agent, a supervisor agent, a customer service agent, or otherwise qualify the agent. Therefore, upon executing a particular implementation of workflow 900 one or more human agents may be scheduled or have tasks enqueued to process tasks requiring human involvement (e.g., step 906 and step 918).

In another embodiment, workflow 900 may be, at least in part, automatically generated and/or modified. For example, if prior users asked for clarification from an agent upon being presented with a particular widget, and the response may be learned by the system and provided automatically as a modified workflow 900.

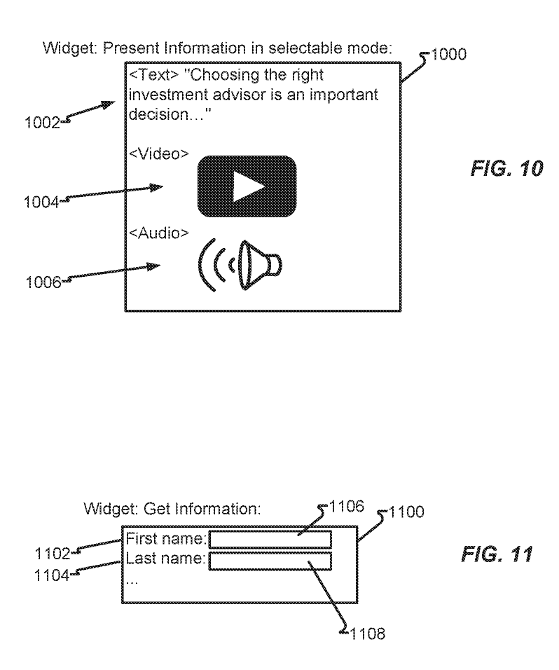

FIG. 10 depicts widget 1000 in accordance with embodiments of the present disclosure. In one embodiment, widget 100 comprises a selectable media type. Text media 1002, video media 1004, and/or audio media 1006 may be selected when widget 1000 is pushed and executed on user device 106. Accordingly, widget 1000 may embed media files and/or embed links (URIs, memory locations, etc.) to cause the media to be available.

FIG. 11 depicts widget 1100 in accordance with embodiments of the present disclosure. In one embodiment, widget 1100 comprises static data 1102, 1104 and input fields 1106, 1108, such as to facilitate the prompting and obtaining of data from a user via an input into user device 106.

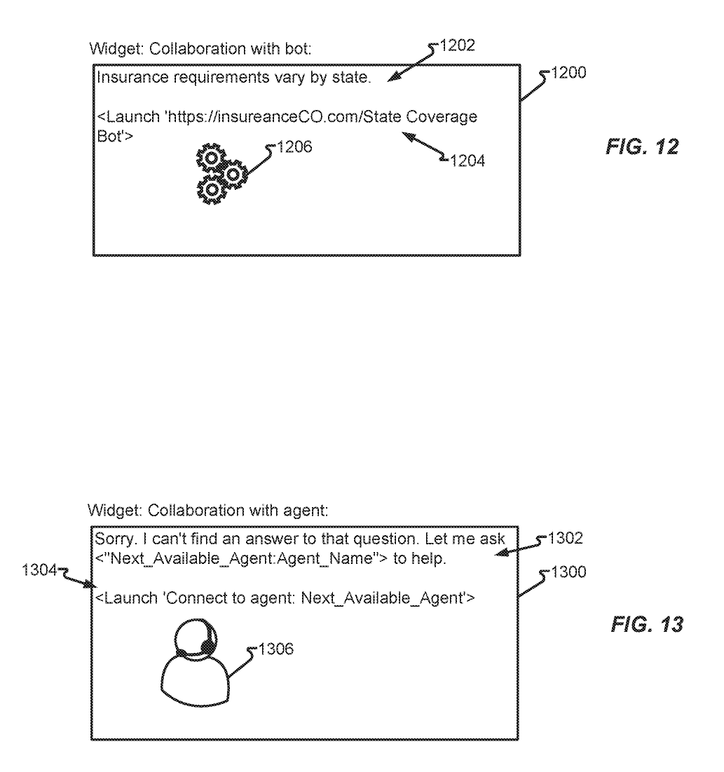

FIG. 12 depicts widget 1200 in accordance with embodiments of the present disclosure. In one embodiment, widget 1200 comprise static information 1202 and link 1204, which may further comprise or be associated with icon 1206. Widget 1200 may then initiate an interaction with a bot, such as a bot associated with link 1204. The interaction may open a separate window on display 202 of user device 106, a separate window in an application executing on user device 106, or within a graphical representation of widget 1200 presented by user device 106. As a benefit, complex interactions (e.g., data that is dynamically determined based on previously obtained data) may be compartmentalized for presentation on user device 106.

FIG. 13 depicts widget 1300 in accordance with embodiments of the present disclosure. In one embodiment, widget 1300 comprises static information 1302 and live interaction link 1304, which may further comprise icon 1306.

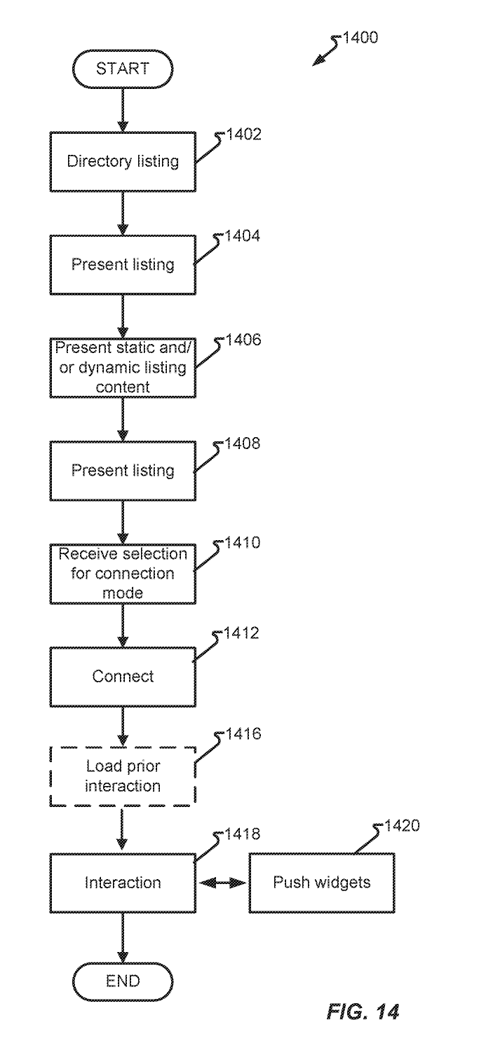

FIG. 14 depicts process 1400 in accordance with embodiments of the present disclosure. In one embodiment, process 1400 is executed, in whole or in part, by at least one processor of user device 106, server 102, and/or server 104. Step 1402 comprises maintaining a directory listing, which may preferably be performed by server 102, indicating a number of listings, such as listings 204. Step 1404 presents the listing upon user device 106, which in turn may be searchable, filterable, or otherwise limited. Step 1406 maintains static (e.g., name, physical address, etc.) and/or dynamic information (e.g., current wait time for a video chat, current availability of text interactions, etc.) which may be obtained via stored records within a database and/or API or other link, such as server 102 accessing an application tracking agent availability that is executing on server 104. Step 1408 presents the listing, such as by user device 106 accessing server 102. Step 1410 receives a selection for an interaction with an entity associated with the listing entry receiving the selection. A search may be a null search criteria, such as to provide all listings.

In another embodiment, optional step 1416 may load a prior interaction, such as when the same user, as identified/verified upon user device 106 in communication with server 102, and the same entity associated with the selected entity indicated in step 1410. Step 1418 then conducts the interaction which may comprise pushing one or more widgets in step 1420.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A mobile messaging platform, comprising:
a user interface that presents a consumer with information describing a plurality of service providers that meet a search criteria entered by the consumer; and
computer memory storing one or more instruction sets, the one or more instruction sets including an instruction set that:
enables a determination of business availability information for at least one of the plurality of service providers, the business availability information including one or more of: (i) a presence notification for the at least one of the plurality of service providers, (ii) a communication modality useable between the consumer and the at least one of the plurality of service providers along with a schedule of availability for the communication modality, and (iii) communication history between the consumer and the at least one of the plurality of service providers; and
enables a presentation of the business availability information via the user interface along with static information associated with the plurality of service providers that meet the search criteria.

2. The mobile messaging platform of claim 1, wherein the business availability information is delivered via a push notification to the user interface.

3. The mobile messaging platform of claim 1, further comprising:
a second user interface that presents a business representative with the communication history between the consumer and the at least one of the plurality of service providers and that enables the business representative to invoke an automated workflow into the communication history such that one or more interactions with the consumer are automated.

4. The mobile messaging platform of claim 3, wherein the automated workflow comprises an automated script that issues at least one prompt to the consumer via the user interface and that receive a consumer response to the at least one prompt via the user interface.

5. The mobile messaging platform of claim 1, wherein a service directory is also presented to the consumer via the user interface and wherein the service directory includes a listing of the plurality of service providers that meet the search criteria and are within a predetermined distance of the consumer.

6. The mobile messaging platform of claim 1, wherein a dynamic contacts list is presented to the consumer via the user interface, wherein the dynamic contacts list is automatically updated to include business representative contacts with whom the consumer has a communication session.

7. A server, comprising:
a data storage;
a network interface to a network; and
a processor to:
maintain, in the data storage, indicia of an entity;
obtain a dynamic attribute, via the network interface, with an entity server of the entity and wherein the dynamic attribute comprises a plurality of communication modes;
receive an entity request, via the network interface, for the indicia from a user device;
send the indicia and dynamic attribute to the user device;
receive a selection of one of the plurality of communication modes, from the user device, to communicate with the entity and wherein the selected communication mode comprises at least a portion of the dynamic attribute; and
connect the user device with the entity utilizing the selected one of the communication modes.

8. The server of claim 7, wherein the processor further:
maintains, in the data storage, a listing comprising a plurality of indicia for a corresponding plurality of entities;
for each of the plurality of entities, obtains, via the network interface, a plurality of dynamic attributes, from each of a corresponding plurality of entity servers comprising a corresponding plurality of communication modes;
sends to the user device the listing comprising the plurality of indicia and the corresponding plurality of dynamic attributes;
receives the selection comprising one of the plurality of indicia and selected communication mode associated with the one of the plurality of indicia;
connects the user device with one of the plurality entities associated with the selected one of the plurality of indicia utilizing the selected one of the corresponding plurality of communication modes.

9. The server of claim 8, wherein the processor causes the listing to be presented on the user device.

10. The server of claim 7, wherein the processor, upon connecting the user device with the entity, facilitates an interaction therebetween.

11. The server of claim 10, wherein the processor records, in the data storage, the interaction.

12. The server of claim 10, wherein the processor, via the network interface, receives an annotation from at least one of the user device or the entity and records the annotation in the data storage.

13. The server of claim 10, wherein the processor, as a portion of the interaction:
receives a signal to pushes a widget to the user device;
accesses, from the data storage, the widget; and
sends the widget to the user device; and
wherein the widget comprises executable instructions for execution by a processor of the user device.

14. The server of claim 13, wherein the widget obtains data from the user device and stores the obtained data in the data storage.

15. The server of claim 7, wherein the dynamic attribute further comprises a delay associated with connecting the user device to the entity comprising one of the plurality of connection modes and waiting for an interaction to be initiated utilizing the one of the plurality of connection modes as the selected connection mode.

16. A method, comprising:
maintaining a listing comprising at least one entry and wherein each entry comprises indicia of an entity;
obtaining, a dynamic attribute for each entry from a corresponding server of the entity and wherein the dynamic attribute comprises a status of a communication mode;
receiving request from a user device for the listing;
in response to the received request, sending the listing;
receiving, from the user device, a selection, comprising a selected one of the at least one entry and the communication mode; and
connecting the user device with the entity utilizing the communication mode.

17. The method of claim 1, wherein:
the dynamic attribute further comprises a plurality of communication modes;
the receiving of the selection comprising the communication mode further comprises a selection of a selected one of the plurality of communication modes; and
the connecting the user device with the entity utilizing the communication mode comprises connecting the user device with the entity utilizing the selected one of the plurality of communication nodes.

18. The method of claim 1, wherein the dynamic attribute comprising a status of a communication mode comprises a wait time associated with connecting the user device with the entity and a delay before an interaction begins utilizing the communication mode.

19. The method of claim 1, wherein the connection comprises an interaction and wherein the interaction comprises at least one widget of executable code by the user device.

20. The method of claim 1, wherein an interaction conducted between the user device and entity is maintained in a persistent data storage and may be resumed in a subsequent communication session occurring after the connection has terminated.
